(19) United States
(12) Patent Application Publication
(10) Pub. No.: US 2025/0166497 A1
(43) Pub. Date: May 22, 2025

(54) APPARATUS AND METHOD FOR PREDICTING TRAFFIC SPEED

(71) Applicants: Hyundai Motor Company, Seoul (KR); Kia Corporation, Seoul (KR)

(72) Inventors: Nam Hyuk KIM, Hwaseong-Si (KR); Won Seok YANG, Hwaseong-Si (KR); Sang Hyeon SHIN, Hwaseong-Si (KR)

(73) Assignees: Hyundai Motor Company, Seoul (KR); Kia Corporation, Seoul (KR)

(21) Appl. No.: 18/896,439

(22) Filed: Sep. 25, 2024

(30) Foreign Application Priority Data
Nov. 20, 2023 (KR) 10-2023-0161402

(51) Int. Cl. G08G 1/01; G08G 1/052

(52) U.S. Cl. CPC G08G 1/0129; G08G 1/0112; G08G 1/0133; G08G 1/052

(57) ABSTRACT

In a traffic speed prediction apparatus and a method therefor, the traffic speed prediction apparatus includes: a processor configured for estimating a path navigation demand based on current path navigation data for each of road sections, and to predict a future traffic speed using the path navigation demand and past speed data from a current time point for each of the road sections; and a storage configured to store algorithms and data driven by the processor.

### CROSS-REFERENCE TO RELATED APPLICATION

The present application claims priority to Korean Patent Application No. 10-2023-0161402, filed on Nov. 20, 2023, the entire contents of which is incorporated herein for all purposes by this reference.

### BACKGROUND OF THE PRESENT DISCLOSURE

### Field of the Present Disclosure

The present disclosure relates to a traffic speed prediction apparatus and a method therefor, and more specifically, to a technique for predicting future traffic speed data by considering path navigation demands.

### Description of Related Art

In metropolitan areas, where traffic congestion incurs enormous social and economic costs, construction and expansion of road infrastructure has limitations in terms of budget constraints and land availability. Accordingly, various traffic information is being provided instead of expanding road infrastructure.

Conventionally, future traffic speed data is predicted using only past speed data, and thus, for paths over a certain time period (long distance paths), it may be difficult to find causality in traffic speed due to traffic volume, and trends may only be predicted based on the assumption that past speed data is repeated. Accordingly, the causality is lacking based on a current time point, and there is no choice but to rely on correlation with past speed data.

Furthermore, conventionally, a total number of probes passing through a traffic collection point is calculated for each time interval, and in the instant case, probe vehicles may be required to pass through all traffic collection points, and thus there is a delay in collecting real-time traffic volume, making it difficult to predict congestion in advance by use of the data in a prediction model.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a traffic speed prediction apparatus and a method therefor, configured for increasing accuracy of future traffic prediction by pre-estimating an expected driving demand for each road section and applying it to the future traffic prediction.

Furthermore, an exemplary embodiment of the present disclosure attempts to provide a traffic speed prediction apparatus and a method therefor, configured for using a number of path navigation requests to determine how many vehicles will reach each road section, and predicting a traffic volume on a corresponding road by estimating a demand for the corresponding road in a case where a user requests the path navigation by entering a destination.

Furthermore, an exemplary embodiment of the present disclosure attempts to provide a traffic speed prediction apparatus and a method therefor, configured for predicting a traffic speed for each road section rather than predicting a traffic speed based on a single road section, accurately predicting traffic congestion.

The technical objects of the present disclosure are not limited to the objects mentioned above, and other technical objects not mentioned may be clearly understood by those skilled in the art from the description of the claims.

An exemplary embodiment of the present disclosure provides a traffic speed prediction apparatus including: a processor configured for estimating a path navigation demand based on current path navigation data for each of road sections, and to predict a future traffic speed using the path navigation demand and past speed data from a current time point for each of the road sections; and a storage configured to store algorithms and data driven by the processor.

In an exemplary embodiment of the present disclosure, the processor may be configured to generate a path navigation demand table based on 3D data including the road sections, a path navigation request time point for each road section, and an arrival time point for each road section.

In an exemplary embodiment of the present disclosure, the processor may be configured to generate a path navigation demand table including a number of vehicles scheduled to arrive for each arrival time point for each road section based on a road section, a time point of a path navigation request for each road section, and an arrival time point for each road section.

In an exemplary embodiment of the present disclosure, the processor may be configured to select the road section using a link section of a road, to divide 24 hours into predetermined first time units to assign an index for each path navigation request time point for each road section, to divide 24 hours into predetermined second time units to assign an index for each arrival time point for each road section, and to generate the path navigation demand table by mapping the index for each path navigation request time point for each road section and the number of vehicles scheduled to arrive for each index for each arrival time point for each road section.

In an exemplary embodiment of the present disclosure, the processor may be configured to determine that the future traffic speed will decrease as the number of vehicles scheduled to arrive for each arrival time point for each road section increases.

In an exemplary embodiment of the present disclosure, the processor may be configured for estimating a demand for each road section according to the number of vehicles scheduled to arrive for each arrival time point for each road section and to estimate the future traffic speed according to the demand.

In an exemplary embodiment of the present disclosure, the processor may be configured for estimating a traffic speed for each road section according to a number of path navigation for each path navigation request time point for each road section.

In an exemplary embodiment of the present disclosure, the processor may be configured to predict the future traffic speed by further reflecting auxiliary data including at least one of weather, day of a week, time of a day, season information, or a combination thereof.

In an exemplary embodiment of the present disclosure, the processor may include: an attention model with past speed data and path navigation data as inputs of the attention model; an embedding layer for embedding the auxiliary data; and a prediction model for predicting the future traffic speed using outputs of the attention model and the embedding layer.

In an exemplary embodiment of the present disclosure, the processor may be configured to select at least one road section for data collection, and to determine whether past speed data, path navigation data, and auxiliary data are normally collected from a probe vehicle in the at least one selected road section, to reselect another road section in response to a case where any of the past speed data, the path navigation data, and the auxiliary data is not collected normally.

In an exemplary embodiment of the present disclosure, the processor may be configured, in response to a case where the past speed data, the path navigation data, and the auxiliary data are normally collected, to configure a path navigation demand table based on the path navigation data.

In an exemplary embodiment of the present disclosure, it may further include a communication device operably connected to the processor and configured to collect the past speed data and the path navigation data from the probe vehicle.

An exemplary embodiment of the present disclosure provides a traffic speed prediction method including: collecting, by a processor, past speed data and path navigation data from a probe vehicle from a current time point for each of road sections; estimating, by the processor, a path navigation demand based on path navigation data at the current time point for each of the road sections; and predicting, by the processor, a future traffic speed using the path navigation demand and past speed data from the current time point for each of the road sections.

In an exemplary embodiment of the present disclosure, the predicting of the future traffic speed may include generating, by the processor, the path navigation demand table based on 3D data including the road sections, a path navigation request time point for each road section, and an arrival time point for each road section.

In an exemplary embodiment of the present disclosure, the predicting of the future traffic speed may include generating, by the processor, a path navigation demand table including a number of vehicles scheduled to arrive for each arrival time point for each road section based on a road section, a time point of a path navigation request for each road section, and an arrival time point for each road section.

In an exemplary embodiment of the present disclosure, the generating of the path navigation demand table may include: selecting, by the processor, the road section using a link section of a road; dividing, by the processor, 24 hours into predetermined first time units to assign an index for each path navigation request time point for each road section; dividing, by the processor, 24 hours into predetermined second time units to assign an index for each arrival time point for each road section; and mapping, by the processor, the index for each path navigation request time point for each road section and the number of vehicles scheduled to arrive for each index for each arrival time point for each road section.

In an exemplary embodiment of the present disclosure, the predicting of the future traffic speed may include determining, by the processor, that the future traffic speed will decrease as the number of vehicles scheduled to arrive for each arrival time point for each road section increases.

In an exemplary embodiment of the present disclosure, the predicting of the future traffic speed may include estimating, by the processor, a demand for each road section according to the number of vehicles scheduled to arrive for each arrival time point for each road section and to estimate the future traffic speed according to the demand.

In an exemplary embodiment of the present disclosure, the predicting of the future traffic speed may include predicting, by the processor, the future traffic speed by further reflecting auxiliary data including at least one of weather, day of a week, time of a day, season information, or a combination thereof.

In an exemplary embodiment of the present disclosure, the predicting of the future traffic speed may include selecting, by the processor, at least one road section for data collection; determining, by the processor, whether past speed data, path navigation data, and auxiliary data are normally collected from a probe vehicle in the at least one selected road section; and reselecting, by the processor, another road section in response to a case where any of the past speed data, the path navigation data, and the auxiliary data is not collected normally.

According to an exemplary embodiment of the present disclosure, it may be possible to increase accuracy of future traffic prediction by pre-estimating an expected driving demand for each road section and applying it to the future traffic prediction.

Furthermore, it may be possible to use a number of path navigation requests to determine how many vehicles will reach each road section, and to predict a traffic volume on a corresponding road by estimating a demand for the corresponding road in a case where a user requests the path navigation by entering a destination.

Furthermore, it may be possible to predict a traffic speed for each road section rather than predicting a traffic speed based on a single road section, accurately predicting traffic congestion.

Furthermore, various effects which may be directly or indirectly identified through the present specification may be provided.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a block diagram showing an example traffic speed prediction apparatus.

FIG. 2 illustrates a structure of an example traffic speed prediction model.

FIG. 3 illustrates an example of a path navigation demand table.

FIG. 4 illustrates a view for describing an example of path navigation data.

FIG. 5 illustrates an example of predicting a future traffic speed using a past traffic speed.

FIG. 6 illustrates a two-dimensional graph for describing an example relationship between a traffic speed, a traffic volume, and a traffic demand.

FIG. 7 illustrates an example diagram expressing a relationship between a traffic speed, a traffic volume, and a traffic demand as a heating map.

FIG. 8A, FIG. 8B, FIG. 8C, and FIG. 8D each illustrate an example diagram showing a traffic speed according to a path demand.

FIG. 9 illustrates a flowchart showing an example traffic speed prediction method.

FIG. 10 illustrates an exemplary computing system.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, some exemplary embodiments of the present disclosure will be described in detail with reference to exemplary drawings. It should be noted that in adding reference numerals to constituent elements of each drawing, the same constituent elements include the same reference numerals as possible even though they are indicated on different drawings. In describing an exemplary embodiment of the present disclosure, when it is determined that a detailed description of the well-known configuration or function associated with the exemplary embodiment of the present disclosure may obscure the gist of the present disclosure, it will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms include the same meanings as those which are generally understood by those skilled in the technical field of the present disclosure to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

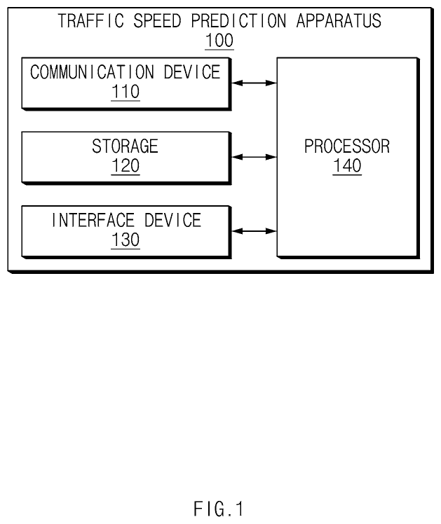

Hereinafter, various exemplary embodiments of the present disclosure will be described in detail with reference to FIG. 1 to FIG. 10.

FIG. 1 illustrates a block diagram showing an example traffic speed prediction apparatus.

The traffic speed prediction apparatus 100 according to an exemplary embodiment of the present disclosure may be implemented in a server outside a vehicle or a center thereof. The traffic speed prediction apparatus 100 may be configured to communicate with vehicles to collect traffic data (speed data, etc.), path navigation data, auxiliary data, etc. from the vehicles, and to provide traffic speed prediction results for vehicles. In the instant case, the auxiliary data may include weather, day of a week, time of a day, season information, etc., and may be provided not only from the vehicle but also from an external server that provides weather, etc.

The traffic speed prediction apparatus 100 may be configured to predict the future traffic speed using past traffic speed data, the path navigation data, and the auxiliary data. In the instant case, the path navigation data may include a number of times a destination has been entered by a user for each road section and a path has been navigated. Accordingly, the traffic speed prediction apparatus 100 may be configured to determine that an expected driving demand for a corresponding road section is high in response to a case where a number of times the path for each road section has been navigated is more than a predetermined number. Furthermore, the traffic speed prediction apparatus 100 may be configured to predict that traffic volume will increase in a road section with high demand for path navigation. In the instant case, the road section may include a link section, and in a case where a user inputs a destination to generate a path, the path may be generated by connecting a plurality of link sections.

Referring to FIG. 1, the traffic speed prediction apparatus 100 may include a communication device 110, a storage 120, an interface device 130, and a processor 140. According to an exemplary embodiment of the present disclosure, the traffic speed prediction apparatus 100 may be implemented as a single unit by coupling components with each other, and some components may be omitted.

The communication device 110 is a hardware device implemented with various electronic circuits to transmit and receive signals through a wireless or wired connection, and may transmit and receive information with components within the traffic speed prediction apparatus 100 based on network communication techniques.

Furthermore, the communication device 110 may communicate with a probe vehicle, etc. through a wireless Internet technique, a mobile communication technique, or a short range communication technique.

Herein, the wireless communication technique may include wireless LAN (WLAN), Wireless Broadband (WiBro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like.

The mobile communication technique may include a mobile communication network established according to technical standards or communication methods for mobile communication (e.g., Global System for Mobile communication (GSM), Code Division Multi Access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), 4th Generation mobile telecommunication (4G), 5th Generation mobile telecommunication (5G), etc, and the communication device 110 may perform communication with a probe vehicle through a mobile communication network.

The wireless Internet technique may include wireless LAN (WLAN), wireless-fidelity (Wi-Fi), Wi-Fi direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), etc. For wireless Internet access, and the communication device 110 may perform communication with a probe vehicle through a mobile communication network.

The short-range communication technique may include short-range communication using at least one of Bluetooth™, radio frequency identification (RFID), infrared data association (IrDA), ultra wideband (UWB), ZigBee, Near Field Communication (NFC), a wireless universal serial bus (USB) technique, or any combination thereof.

For example, the communication device 110 may receive traffic data (speed data), path navigation data, auxiliary data, etc. from a probe vehicle, and may provide the predicted future traffic speed to the vehicle.

The storage 120 may store data and/or algorithms required for the processor 140 to operate, and the like.

For example, the storage 120 may store the traffic data (speed data), the path navigation data, the auxiliary data, etc. received from the probe vehicle. Furthermore, the storage 120 may store information such as a future traffic speed predicted by the processor 140.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the apparatus 100 and results thereof. Herein, the input means may include a key button, and may include a mouse, a joystick, a jog shuttle, a stylus pen, and the like. Furthermore, the input means may include a soft key implemented on the display.

The output device may include a display, and may also include a voice output means such as a speaker. In the instant case, in a response to a case that a touch sensor formed of a touch film, a touch sheet, or a touch pad is provided on the display, the display may operate as a touch screen, and may be implemented in a form in which an input device and an output device are integrated. In an exemplary embodiment of the present disclosure, the output device may output predicted traffic speed information and traffic volume for each road section.

In the instant case, the display may include at least one of a liquid crystal display (LCD), a thin film transistor liquid crystal display (TFT LCD), an organic light-emitting diode display (OLED display), a flexible display, a field emission display (FED), and a 3D display.

The processor 140 may be electrically connected to the communication device 110, the storage 120, the interface device 130, and the like, may electrically control each component, and may be an electrical circuit that executes software commands, performing various data processing and calculations described below.

The processor 140 may be configured to process signals transmitted between each component of the traffic speed prediction apparatus 100 and to perform overall control so that each component may normally perform its function. The processor 140 may be implemented in a form of hardware, software, or a combination of and software. For example, the processor 140 may be implemented as a microprocessor, but the present disclosure is not limited thereto.

The processor 140 may be configured to predict the future traffic speed by estimating the path navigation demand based on the past speed data from a current time for each of the road sections and the path navigation data at the current time. In the instant case, the path navigation demand may be reflected as a path navigation demand table.

The processor 140 may be configured to generate the path navigation demand table based on 3D data, including multiple road sections, a path navigation request time point for each road section, and an arrival time point for each road section. Furthermore, the processor 140 may be configured to generate a path navigation demand table including a number of vehicles scheduled to arrive for each arrival time point for each road section based on a road section, a time point of a path navigation request for each road section, and an arrival time point for each road section.

The processor 140 may be configured to select a road section using a link section of a road, to divide 24 hours into predetermined first time units (e.g., 10 minutes) and assign an index for each path navigation request time point for each road section, and to divide 24 hours into predetermined second time units (e.g., 5 minutes) and assign an index for each arrival time point for each road section. Furthermore, the processor 140 may be configured to generate the path navigation demand table by mapping the index for each path navigation request time point for each road section and the number of vehicles scheduled to arrive for each index for each arrival time point for each road section.

The processor 140 may be configured to determine that the future traffic speed will decrease as the number of vehicles scheduled to arrive for each arrival time point for each road section increases.

The processor 140 may be configured for estimating a demand for each road section according to the number of vehicles scheduled to arrive for each arrival time point for each road section and to estimate the future traffic speed according to the demand.

The processor 140 may be configured for estimating the traffic speed for each road section according to a number of path navigation for each path navigation request time point for each road section.

The processor 140 may be configured to predict the future traffic speed by further reflecting auxiliary data including at least one of weather, day of a week, time of a day, season information, or a combination thereof.

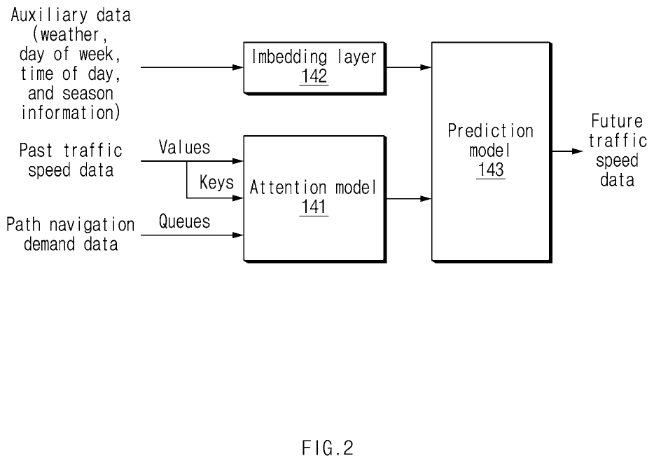

The processor 140 may include an attention model with past speed data and path navigation data as inputs of the attention model thereof, an embedding layer for embedding the auxiliary data, and a prediction model for predicting the future traffic speed using outputs of the attention model and the embedding layer, and this will be described in detail later with reference to FIG. 2.

The processor 140 may be configured to select at least one road section for data collection, and to determine whether past speed data, path navigation data, and auxiliary data are normally collected from a probe vehicle in the at least one selected road section, to reselect another road section in response to a case where any of the past speed data, the path navigation data, and the auxiliary data is not collected normally. Thereafter, the processor 140 may be configured to collect data from other reselected road sections to predict the future traffic speed. At this time, if the collected data exists, the processor 140 may be configured to determine that the data was collected normally, and if the collected data does not exist, determine that the data was not collected normally.

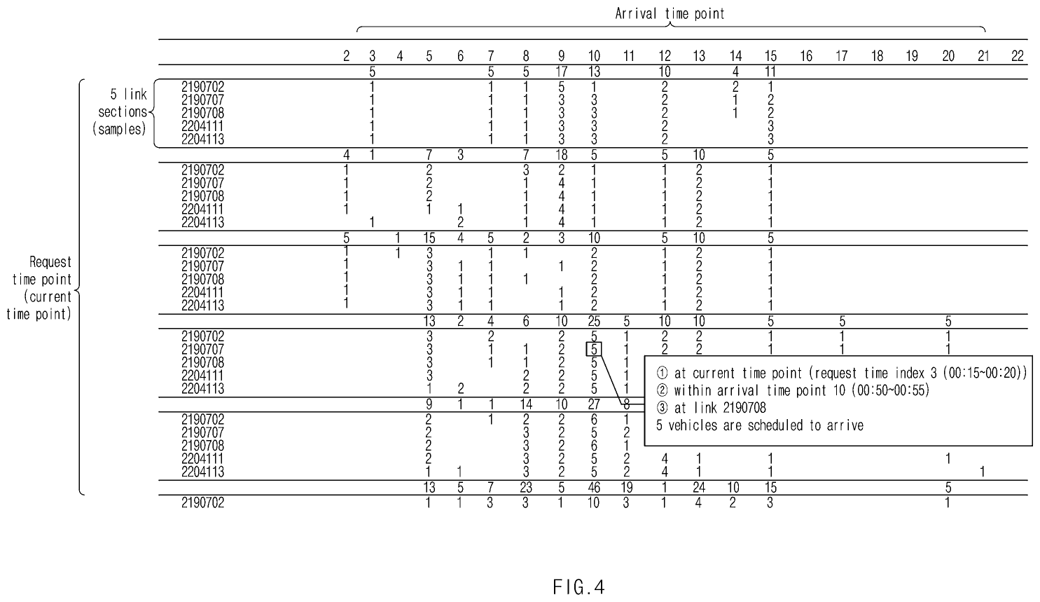

In response to a case where the past speed data, the path navigation data, and the auxiliary data are normally collected, the processor 140 may be configured to configure a path navigation demand table based on the path navigation data. The path navigation demand table will be described later with reference to FIG. 4.

FIG. 2 illustrates a structure of an example traffic speed prediction model.

Referring to FIG. 2, an attention model 141 may use past traffic speed data and path navigation data as inputs of the attention model.

A current traffic situation and path navigation demand data are each input as queues, keys, and values of the attention model 141. The attention model 141, which explores factors attributable to future output, may be applied to easily identify causality with a future traffic speed.

The attention model 141, which is a model that allows a deep learning model to focus on a most important vector among vector sequences, may use a typical attention model.

An embedding layer 142 may embed auxiliary data such as weather, day of a week, time of a day, and season information and may input a result thereof into a prediction model 143.

The prediction model (Prediction mode) 143 may be configured to predict future traffic speed data using the embedded auxiliary data of the embedding layer 142 and the output value of the attention model 141.

The prediction model 143 may reflect existing traffic data reflecting the current traffic situation and path navigation demand data scheduled to arrive at a later time point.

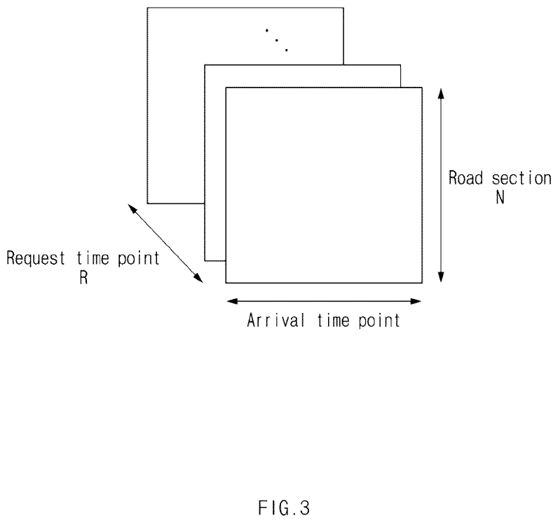

FIG. 3 illustrates an example of a path navigation demand table, and FIG. 4 illustrates a view for describing an example of path navigation data.

Referring to FIG. 3, the path navigation demand table may include a three-dimensional structure in which a horizontal axis represents an arrival time point, a vertical axis represents a request time point, and a height axis represents a road section. For example, the path navigation demand table has three-dimensional data (N×E×R) with variables of a road section N, an arrival time point E, and a request time point R.

The arrival time point refers to a time point at which a vehicle reaches the road section. The arrival time point may be divided into 5-minute intervals from 00:00 to 24:00, and may be displayed as an index at each 5-minute interval. For example, in a case of 00:50 to 00:55, the index may be 10. For example, in response to a case where a user enters a destination to navigate a path, a path to the destination is generated by connecting numerous link sections from a current position of the user to the destination. In the instant case, the link section is called a road section, and refers to a time point at which the vehicle reaches each road section. For example, in a case of reaching the destination through a first link, a second link, a third link, and a fourth link from the current position, a time point at which the vehicle reaches the first link, a time point at which the vehicle reaches the second link, a time point at which the vehicle reaches the third link, and a time point at which the vehicle reaches the fourth link are each called an arrival time point for each road section. In the instant case, as the number of vehicles reaching each road section increases, likelihood of congestion may increase.

The request time point may refer to a time point at which path navigation is requested, and may be divided into 5-minute intervals from 00:00 to 24:00 and may be displayed as an index for each minute interval. For example, in a case of 00:15 to 00:20, the index may be 3.

The road section may refer to the link section as a minimum basic distance unit for collecting average speeds.

Referring to FIG. 4, the request time point, the road section (link section), and the arrival time point are shown two-dimensionally.

The request time point and the link section may be displayed at a vertical side, and the request time point may be indicated by 5 samples with indices 0, 1, 2, 3, and 4, and 6 link sections are used as an example for each request time point.

A horizontal side displays the arrival time point and indexes 2 to 21.

For example, it may be seen that there are 5 vehicles scheduled to arrive in a case where the request time point (current time point) is index 3, the arrival time point is index 10, and the link section is “2190708.”

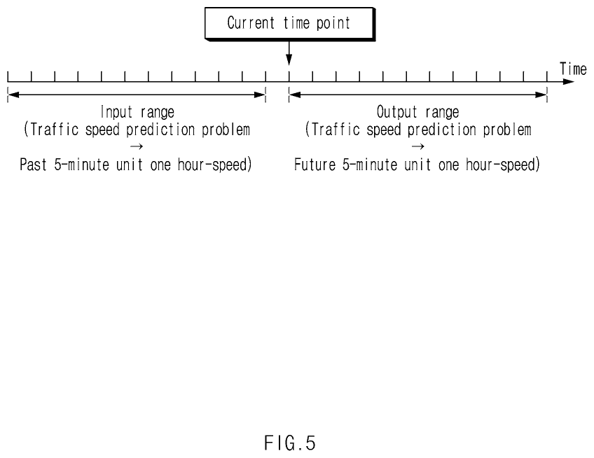

FIG. 5 illustrates an example of predicting a future traffic speed using a past traffic speed.

Referring to FIG. 5, one hour of speed data may be collected every five minutes in the past, and one hour of speed data may be predicted every five minutes in the future from the current time point.

However, in a case of predicting the future speed using only past speed data as illustrated in FIG. 5, long-distance prediction accuracy may be low.

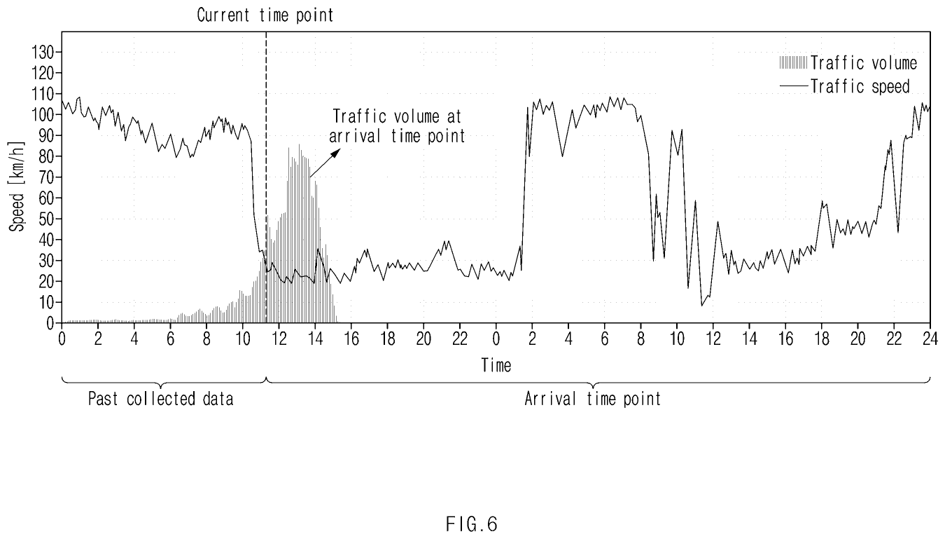

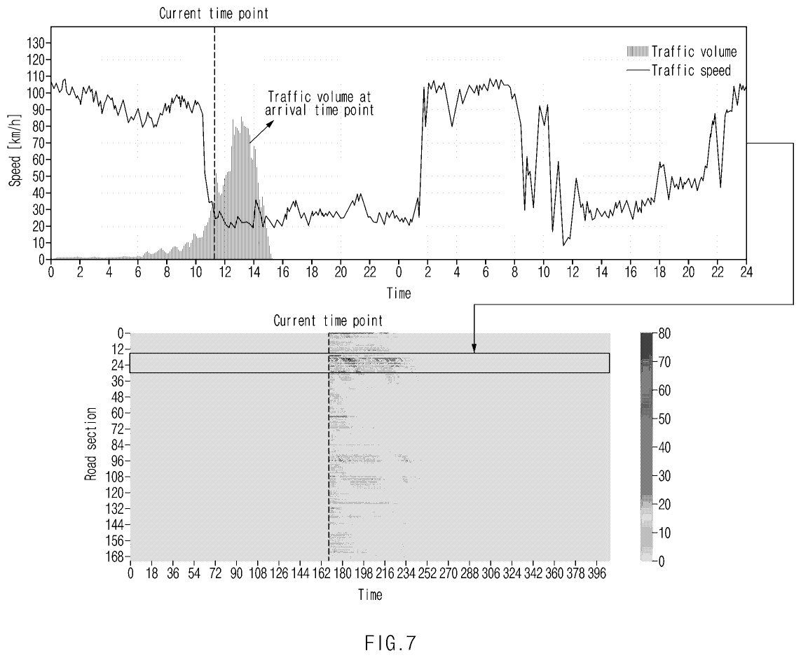

FIG. 6 illustrates a two-dimensional graph for describing an example relationship between a traffic speed, a traffic volume, and a traffic demand, and FIG. 7 illustrates an example diagram expressing a relationship between a traffic speed, a traffic volume, and a traffic demand as a heating map.

Referring to FIG. 6, the future traffic speed may be predicted using speed data of a past data collection section, a traffic volume from the current time point to the arrival time point, and a traffic speed at the arrival time point based on the current time point. In FIG. 6, a relationship between traffic speed, traffic volume, and traffic demand within a single road section may be known. Demand predictability may be strengthened in consideration of connectivity between links by expanding links that will come to a corresponding point after the current time point into multiple links. FIG. 7 illustrates a diagram expressing the two-dimensional graph of FIG. 6 as a hitting map.

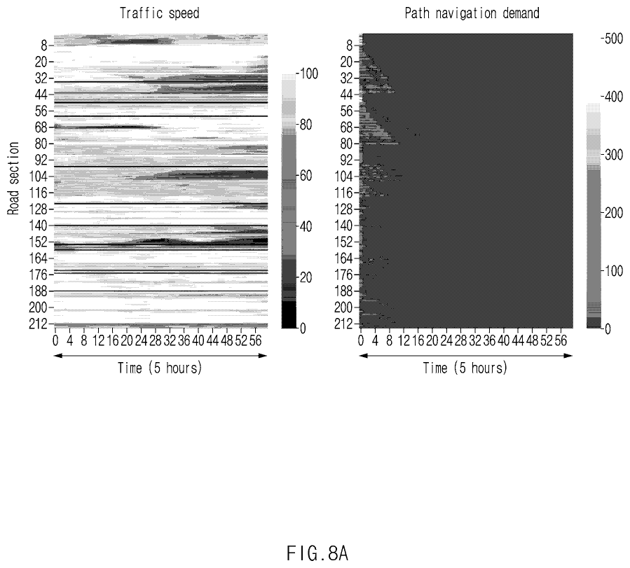

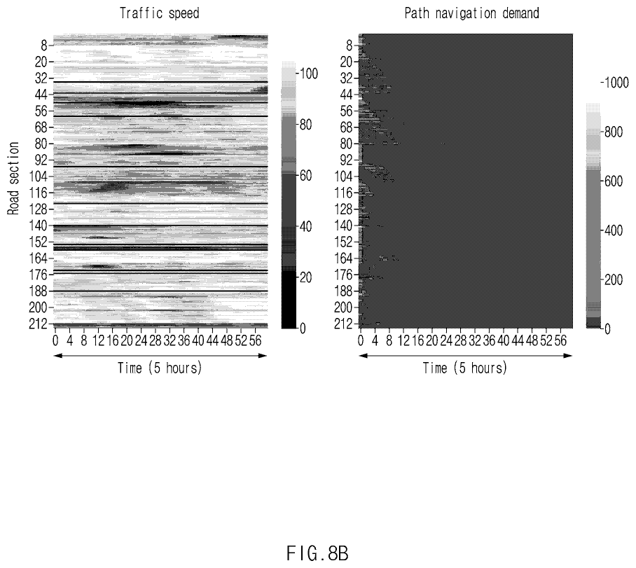

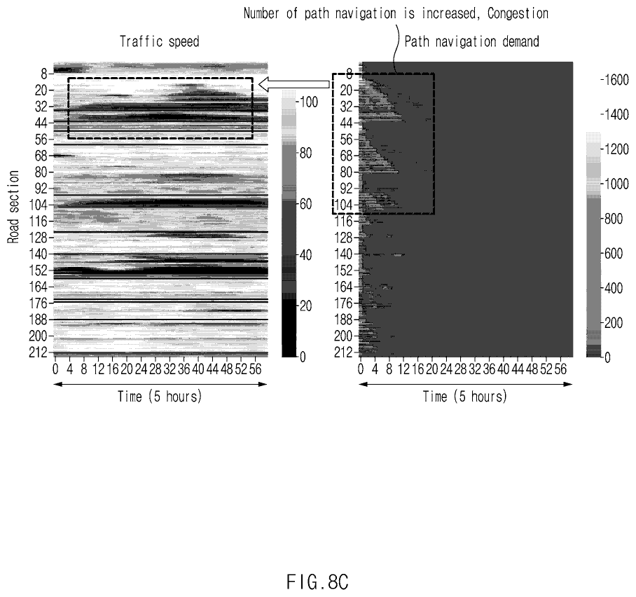

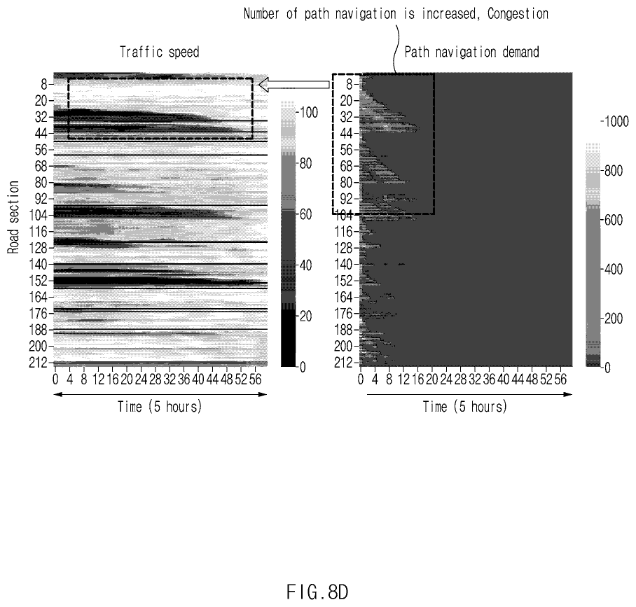

FIG. 8A, FIG. 8B, FIG. 8C, and FIG. 8D each illustrate an example diagram showing a traffic speed according to a path demand. FIG. 8A, FIG. 8B, FIG. 8C, and FIG. 8D show actual speed changes according to the path demand.

FIG. 8A and FIG. 8B illustrate an example diagram for a case where the path demand is low.

It shows a traffic speed trend for 216 road sections and indicates a case where there is little demand for path navigation. In the instant case, there is little demand for path navigation, there are very few sections with low traffic speeds due to low traffic volume.

On the other hand, FIG. 8C and FIG. 8D illustrate an example of a case where the path demand is high.

It may be seen that traffic volume is increased at points 12 and 14, which have high demand for path navigation on 216 road sections, to decrease traffic speed, leading to congestion at points 11 and 13.

In the present way, it may be seen that actual traffic volume increases in sections and time points at which path navigation increases compared to usual, resulting in low traffic speeds and congestion.

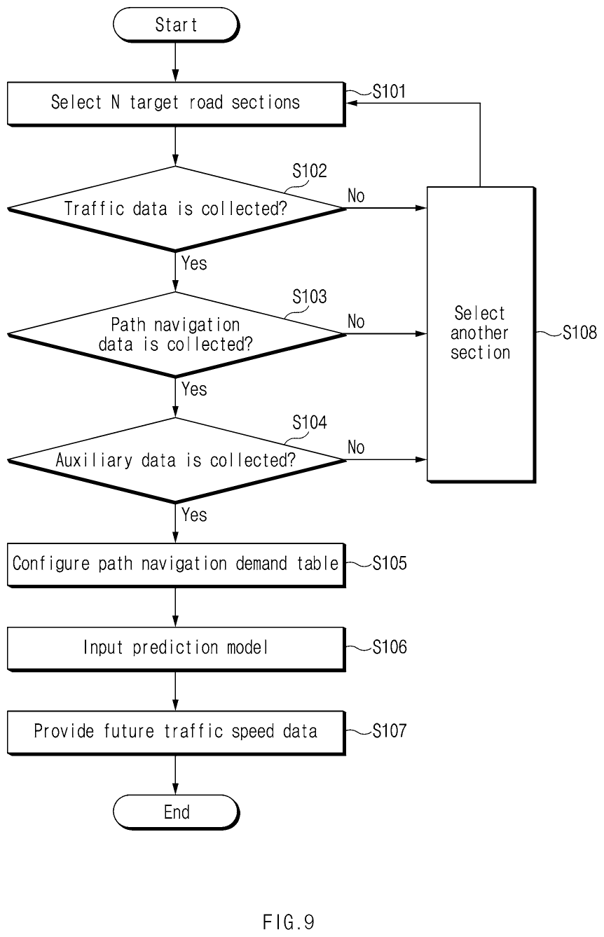

Hereinafter, a traffic speed prediction method according to an exemplary embodiment of the present disclosure will be described with reference to FIG. 9. FIG. 9 illustrates a flowchart showing an example traffic speed prediction method.

Hereinafter, it is assumed that the traffic speed prediction apparatus 100 of the of FIG. 1 is configured to perform processes of FIG. 9. Furthermore, in the description of FIG. 9, operations described as being performed by a device may be understood as being controlled by the processor 140 of the traffic speed prediction apparatus 100. In following exemplary embodiments of the present disclosure, operations of steps S101 to S109 may be performed sequentially, but are not necessarily performed sequentially. For example, an order of each operation may be changed, and at least two operations may be performed in parallel.

Referring to FIG. 9, the traffic speed prediction apparatus 100 may be configured to select N target road sections (S101). In the instant case, the N number may be determined in advance by experimental values, and may be, e.g., 216 or 1000. In the instant case, the selected N road sections may be configured as a target road network considering connectivity.

The traffic speed prediction apparatus 100 may be configured to determine whether traffic data, path navigation data, and auxiliary data are collected (S102, S103, S104).

The traffic speed prediction apparatus 100 may be configured to reselect another road section in response to a case where at least one of the traffic data, the path navigation data, or the auxiliary data is not collected (S108).

The traffic speed prediction apparatus 100 may be configured to configure the path navigation demand table in response to a case where the traffic data, the path navigation data, and the auxiliary data are all normally collected from the selected N road sections (S105).

The traffic speed prediction apparatus 100 may be configured to input the past traffic speed data and the path navigation data into an attention model, and to input output data of the attention model and the auxiliary data into a prediction model (S106).

The traffic speed prediction apparatus 100 may be configured to determine future traffic speed data through the prediction model and to provide the future traffic speed data to vehicles (S107). After that, the traffic speed prediction apparatus 100 provides the predicted future traffic speed data to the vehicle.

Accordingly, according to an exemplary embodiment of the present disclosure, it may be possible to estimate a traffic situation at a time point of reaching a future road section by requesting path navigation and estimating a number of vehicles for each road section of driving vehicles.

That is, an existing prediction model based on past speed data collected to date may improve prediction accuracy of a traffic speed prediction model by solving a problem of difficulty reflecting current and future traffic conditions.

Furthermore, according to an exemplary embodiment of the present disclosure, it may be possible to improve path navigation reliability and user satisfaction by lowering the traffic speed to guide it to a detour in response to a case where the estimated traffic demand on a specific road is excessive compared to usual.

Furthermore, a congestion level for each time zone may be estimated at a point of interest (POI) by estimating a future demand of surrounding links of the POI, and user satisfaction may be increased by making recommendations based on user preferences, such as users who want to avoid congestion.

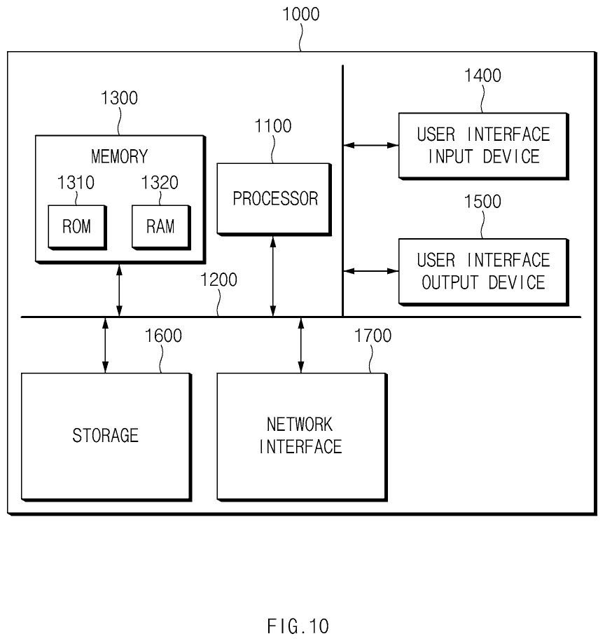

FIG. 10 illustrates an example computing system.

Referring to FIG. 10, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device which is configured to perform processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A traffic speed prediction apparatus comprising:
a processor configured for estimating a path navigation demand based on current path navigation data for each of road sections, and to predict a future traffic speed using the path navigation demand and past speed data from a current time point for each of the road sections; and
a storage configured to store algorithms and data driven by the processor.

2. The traffic speed prediction apparatus of claim 1, wherein the processor is further configured to generate a path navigation demand table based on 3D data including the road sections, a path navigation request time point for each road section, and an arrival time point for each road section.

3. The traffic speed prediction apparatus of claim 1, wherein the processor is further configured to generate a path navigation demand table including a number of vehicles scheduled to arrive for each arrival time point for each road section based on a road section, a time point of a path navigation request for each road section, and an arrival time point for each road section.

4. The traffic speed prediction apparatus of claim 3, wherein the processor is further configured:
to select the road section using a link section of a road,
to divide 24 hours into predetermined first time units to assign an index for each path navigation request time point for each road section,
to divide 24 hours into predetermined second time units to assign an index for each arrival time point for each road section, and
to generate the path navigation demand table by mapping the index for each path navigation request time point for each road section and the number of vehicles scheduled to arrive for each index for each arrival time point for each road section.

5. The traffic speed prediction apparatus of claim 3, wherein the processor is further configured to determine that the future traffic speed will decrease as the number of vehicles scheduled to arrive for each arrival time point for each road section increases.

6. The traffic speed prediction apparatus of claim 3, wherein the processor is further configured for estimating a demand for each road section according to the number of vehicles scheduled to arrive for each arrival time point for each road section and to estimate the future traffic speed according to the demand.

7. The traffic speed prediction apparatus of claim 1, wherein the processor is further configured for estimating a traffic speed for each road section according to a number of path navigation for each path navigation request time point for each road section.

8. The traffic speed prediction apparatus of claim 1, wherein the processor is further configured to predict the future traffic speed by further reflecting auxiliary data including at least one of weather, day of a week, time of a day, season information, or a combination thereof.

9. The traffic speed prediction apparatus of claim 8, wherein the processor includes:
an attention model with the past speed data and the path navigation data as inputs of the attention model;
an embedding layer for embedding the auxiliary data; and
a prediction model for predicting the future traffic speed using outputs of the attention model and the embedding layer.

10. The traffic speed prediction apparatus of claim 8, wherein the processor is further configured:
to select at least one road section for data collection, and
to determine whether the past speed data, path navigation data, and the auxiliary data are normally collected from a probe vehicle in the at least one selected road section,
to reselect another road section in response to a case where any of the past speed data, the path navigation data, and the auxiliary data is not collected normally.

11. The traffic speed prediction apparatus of claim 10, wherein the processor is further configured:
in response to a case where the past speed data, the path navigation data, and the auxiliary data are normally collected, to configure a path navigation demand table based on the path navigation data.

12. The traffic speed prediction apparatus of claim 1, further including:
a communication device operably connected to the processor and configured to collect the past speed data and the path navigation data from a probe vehicle.

13. A traffic speed prediction method comprising:
collecting, by a processor, past speed data and path navigation data from a probe vehicle from a current time point for each of road sections;
estimating, by the processor, a path navigation demand based on the path navigation data at the current time point for each of the road sections; and
predicting, by the processor, a future traffic speed using the path navigation demand and the past speed data from the current time point for each of the road sections.

14. The traffic speed prediction method of claim 13, wherein the predicting of the future traffic speed includes:
generating, by the processor, a path navigation demand table based on 3D data including the road sections, a path navigation request time point for each road section, and an arrival time point for each road section.

15. The traffic speed prediction method of claim 13, wherein the predicting of the future traffic speed includes:
generating, by the processor, a path navigation demand table including a number of vehicles scheduled to arrive for each arrival time point for each road section based on a road section, a time point of a path navigation request for each road section, and an arrival time point for each road section.

16. The traffic speed prediction method of claim 15, wherein the generating of the path navigation demand table includes:
selecting, by the processor, the road section using a link section of a road;
dividing, by the processor, 24 hours into predetermined first time units to assign an index for each path navigation request time point for each road section;
dividing, by the processor, 24 hours into predetermined second time units to assign an index for each arrival time point for each road section; and
mapping, by the processor, the index for each path navigation request time point for each road section and the number of vehicles scheduled to arrive for each index for each arrival time point for each road section.

17. The traffic speed prediction method of claim 16, wherein the predicting of the future traffic speed includes:
determining, by the processor, that the future traffic speed will decrease as the number of vehicles scheduled to arrive for each arrival time point for each road section increases.

18. The traffic speed prediction method of claim 16, wherein the predicting of the future traffic speed includes:
estimating, by the processor, a demand for each road section according to the number of vehicles scheduled to arrive for each arrival time point for each road section and to estimate the future traffic speed according to the demand.

19. The traffic speed prediction method of claim 13, wherein the predicting of the future traffic speed includes:
predicting, by the processor, the future traffic speed by further reflecting auxiliary data including at least one of weather, day of a week, time of a day, season information, or a combination thereof.

20. The traffic speed prediction method of claim 13, wherein the predicting of the future traffic speed includes:
selecting, by the processor, at least one road section for data collection;
determining, by the processor, whether the past speed data, the path navigation data, and the auxiliary data are normally collected from the probe vehicle in the at least one selected road section; and
reselecting, by the processor, another road section in response to a case where any of the past speed data, the path navigation data, and the auxiliary data is not collected normally.
